(19) United States
(12) Patent Application Publication
(10) Pub. No.: US 2006/0173753 A1
(43) Pub. Date: Aug. 3, 2006

(54) Method and system for online shopping

(75) Inventors: Ranjit Padmanabhan, Palo Alto, CA (US); Dhiraj Pardasani, Palo Alto, CA (US); Alex Meyer, Palo Alto, CA (US); Shashikant Khandelwal, Palo Alto, CA (US); Nanda Kishore, Palo Alto, CA (US)

Correspondence Address: William L. Botjer, PO Box 478, Center Moriches, NY, 11934, US

(73) Assignee: FATLENS, INC.

(21) Appl. No.: 11/113,567

(22) Filed: Apr. 25, 2005

Related U.S. Application Data
(60) Provisional application No. 60/643,946, filed on Jan. 14, 2005.

(51) Int. Cl. G06F 17/30

(52) U.S. Cl. 705/27

(57) ABSTRACT

The invention provides a business method and a system to perform focused online shopping and sharing the online shopping experience with other users. The shopping-related information from various sources, and the search query, is converted into directed acyclic graph forests. These graphs are then compared to identify the search results that correspond to the shopping criteria. The sharing of online shopping experience includes sharing of search results between multiple users, discussing the search results through instant messaging (IM), revision of relevant items by any or all users and the flexibility of online-purchase by any user.

### REFERENCE TO RELATED APPLICATIONS

This patent application claims priority of U.S. Provisional Patent Application No. 60/643,946 filed on Jan. 14, 2005

This patent application hereby incorporates by reference U.S. Provisional Patent Application No. 60/643,924 filed on Jan. 14, 2005, titled “Method and System for Information Extraction”; and U.S. Provisional Patent Application No. 60/643,947 filed on Jan. 14, 2005, titled “Method and System to Compare Data Objects”.

### BACKGROUND

The invention relates to the field of online shopping. More specifically, the invention relates to providing enhanced online shopping experience, by allowing the user to customize the experience and share it with other users.

With the increased use of the Internet in the present times, online shopping has become a very popular method to carry out market place transactions: Further, searching for online product information has also become increasingly popular. The various sources of product information, such as the Internet, store information mainly in an unstructured and unorganized form. There is no common syntax or form of representing the information. Therefore, there is a need of product information search techniques that can help in extracting relevant information from volumes of unstructured information available at different sources of information.

Several information search techniques are known in the art. One of the techniques is keyword search. In keyword search, keywords that relate to a particular information domain are used to search in the information sources.

Another methodology is wrapper induction search. It is a procedure designed to extract information from the information sources using pre-defined templates. Instead of reading the text at the sentence level, wrapper induction systems identify relevant content based on the textual qualities that surround the desired data. For example, a job application form may contain pre-defined templates for various fields such as name, age, qualification, etc. The wrappers, therefore, can easily extract information pertaining to these fields without reading the text on the sentence level.

However, the above-mentioned methodologies suffer from one or more of the following disadvantages. The keyword search methodologies generally do not produce complete search results. This is because these methodologies do not recognize the context in which a particular searched keyword has appeared. For example, if a user inputs the name of the artist and is looking for the artist's upcoming concerts, the technique may also generate results that may be related to the personal life of the artist. This type of information will be irrelevant for a person who is looking for tickets to the artist's show. Therefore, many non-relevant data sets may also get identified in the search results.

Further, they fail to incorporate the synonyms and connotations of the keywords that are present in natural language content. For example, one of the keywords that can be used for an upcoming concert's tickets is ‘concert’. The conventional techniques do not incorporate the synonyms, such as show, program, performance etc.

Wrapper induction methodology proves inefficient in cases where there is a lack of common structural features in the varied information sources.

In light of the above disadvantages, it is apparent that there is a need for a methodology for searching product related information that is able to identify the data objects that relate to an information domain. There is a need for a methodology that converts data objects into structured representations in order to compare the data objects. Further, there is a need for a methodology that compares the context in which keywords are used in data objects.

Moreover, when a user wants to purchase a product online, the user often seeks advice from friends or informal experts. Typically, the user searches for the product information, seeks advice from friends and re-iterates the search. At times, this becomes a time-consuming and painstaking exercise.

It is therefore apparent that there is a need for an online shopping methodology, through which a user can share the shopping experience with other users. Further, there is a need for an online shopping methodology which can shorten the buying cycle and add a fun element to the online shopping experience.

### SUMMARY

It is an object of the invention to enable sharing of search results between multiple users, discussing the search results through instant messaging (IM) and the flexibility of online-purchase by any user. Further, an object of the invention is to shorten the buying cycle for online shopping and enhance the online shopping experience.

According to one embodiment of the invention, the invention provides a business method and a system to provide a focused online shopping experience. The method comprises the following steps: First, pertinent shopping-related information is extracted from a data set and stored in the form of a set of information-based directed acyclic graph (DAG) forests. Second, a search query entered by a user is converted into a query-based DAG forest. Third, relevant search results are identified by comparing the query-based DAG forest with the information-based DAG forests. Fourth, the relevant results are displayed to the user, in order to enable the user to make a shopping decision.

Further, the invention provides a method and a system to share the online-shopping experience with other users. The method comprises the following steps: First invitees are invited through an instant messaging platform to view the relevant results searched by the user. Second, the relevant results are displayed to the invitees. Third, the relevant results are discussed over the instant messaging platform between the user and the invitees. Fourth, the relevant result list may be modified, i.e. results may be added or removed, by the user or any invitee.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is block diagram representing a system that allows users to shop online, in accordance with one embodiment of the invention;

FIG. 2 is a flowchart representing a method for performing online shopping, in accordance with one embodiment of the invention;

FIG. 3 is a flowchart representing a method for sharing the online shopping experience with other users, in accordance with one embodiment of the invention; and

FIGS. 4A, 4B, 4C, and 4D are representations of the user interface during the execution of the method of sharing online experience, in accordance with one embodiment of the invention.

### DESCRIPTION OF PREFERRED EMBODIMENTS

The invention provides a business method and a system to perform focused online shopping and sharing the online shopping experience with other users. The sharing of online shopping experience includes sharing of search results between multiple users, discussing the search results through instant messaging (IM) and the flexibility of online-purchase by any user.

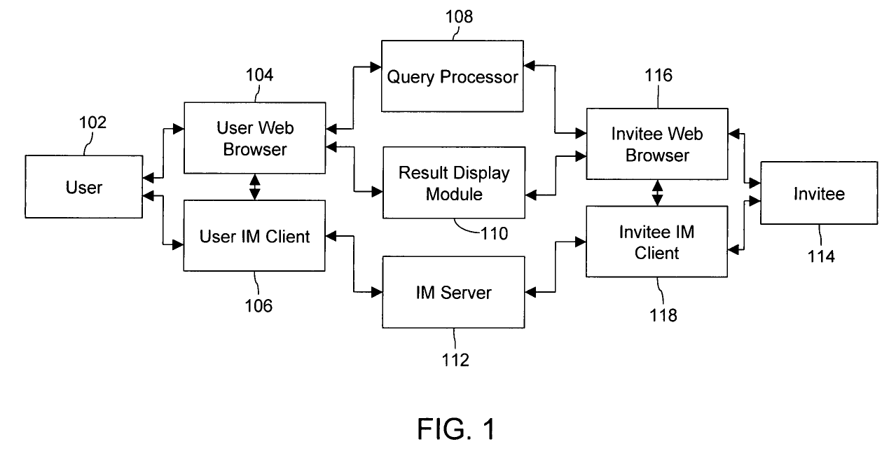

FIG. 1 is block diagram representing a system that allows users to shop online, in accordance with one embodiment of the invention. A user 102 interfaces with a user web browser 104 and a user IM client 106. User 102 can access a query processor 108 and a result display module 1 10 through user web-browser 104. Further, user IM client 106 communicates with an IM server 112. An invitee 114 is also connected to query processor 108, result display module 110 and IM server 112. Invitee 114 is connected to query processor 108 and result display module 110 through an invitee web browser 116. Further, invitee 114 is connected to IM server 112 through an invitee IM client 118.

User web browser 104 and invitee web browser 116 are user interfaces to access a network e.g. the Internet. Examples of user web browser 104 and invitee web browser 116 include Internet Explorer™ provided by Microsoft Corporation, Netscape™, and Mozilla™.

User IM client 106 and invitee IM client 118 are instant messaging client applications. Instant messaging client applications are provided by various IM services, for example, Yahoo Messenger™, AOL Instant Messenger (AIM™), etc. According to one embodiment of the invention, these client applications are present on the computer terminals of user 102 and invitee 114. User IM client 106 is capable of communicating with user web browser 104, and invitee IM client 118 is capable of communicating with invitee web browser 116.

IM server 112 enables communication between user IM client 106 and invitee IM client 118. IM server 112 is provided by various instant messaging services, for example, Yahoo Messenger™, AOL Instant Messenger (AIM™), etc.

Query processor 108 is capable of receiving a search query, performing a search, and generating relevant search results. The search query pertains to a shopping objective of the user. For example, if the shopping objective of the user is to purchase concert tickets, then the search query may be “Madonna concert ticket 50$”. According to one embodiment of the invention, query processor 108 stores pre-extracted data from the Internet in the form of an information-based directed acyclic graph forest. The details of information extraction are given in the cross-referenced U.S. Provisional Patent Application No. 60/643,924 filed on Jan. 14, 2005, titled “Method and System for Information Extraction”.

A directed acyclic graph forest is a set of one or more directed acyclic graphs. A directed acyclic graph is a representation of a set of items, each of which is associated with a node of the graph. All the nodes of a directed acyclic graph are connected by edges or logical connections, which are unidirectional in nature. Further, a route traced along connected edges, in the direction specified by the edges, never ends on a node from which the route starts.

Query processor 108 also converts a search query into a query-based directed acyclic graph forest and comparing the information-based directed acyclic graph forest and the query-based directed acyclic graph forest to generate the relevant search results.

The method of converting shopping related information and search query into directed acyclic graph forests and the method for calculating the similarity scores between the directed acyclic graph forests is provided in the cross-referenced U.S. Provisional Patent Application No. 60/643,947 filed on Jan. 14, 2005, titled “Method and System to Compare Data Objects”.

Result display module 110 displays the relevant search results to user 102 and to invitee 114. These relevant results are displayed on user web browser 104 and invitee web browser 116. Although only one invitee 114 has been illustrated in FIG. 1, several invitees 114 may be present.

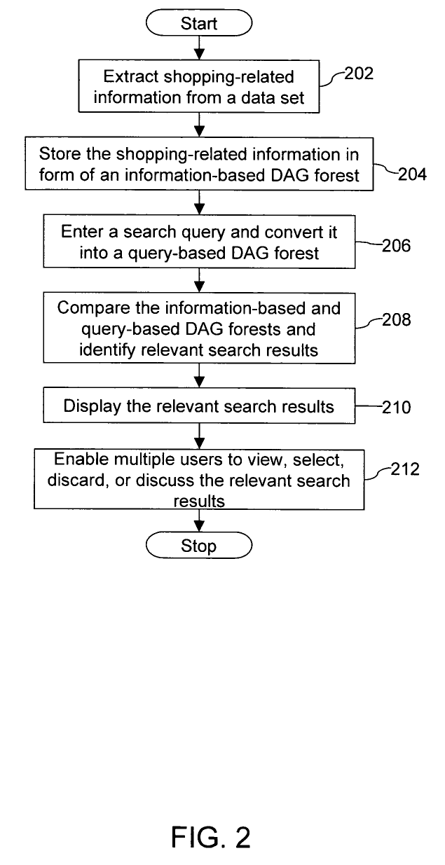

FIG. 2 is a flowchart representing a method for performing online shopping, in accordance with one embodiment of the invention. At step 202, shopping related information is extracted from various sources e.g. the Internet. The details of the method for extracting information are given in the cross-referenced U.S. Provisional Patent Application No. 60/643,924 filed on Jan. 14, 2005, titled “Method and System for Information Extraction”.

At step 204, the shopping-related information is stored in form of information-based directed acyclic graph forests. Further, at step 206, the search query received from a user is converted into a query-based directed acyclic graph forest. The search query pertains to a shopping objective, such as online purchase of tickets, of the user. At step 208, the information-based directed acyclic graph forests is compared with the query-based acyclic graph forest and similarity scores between information-based directed acyclic graph forests and the query-based acyclic graph forest are calculated.

The method of converting shopping related information and search query into directed acyclic graph forests and the method for calculating the similarity scores between the directed acyclic graph forests is provided in the cross-referenced U.S. Provisional Patent Application No. 60/643,947 filed on Jan. 14, 2005, titled “Method and System to Compare Data Objects”. Based on the similarity scores calculated, relevant search results are identified.

At step 210, the relevant search results identified in step 208 are displayed to the user.

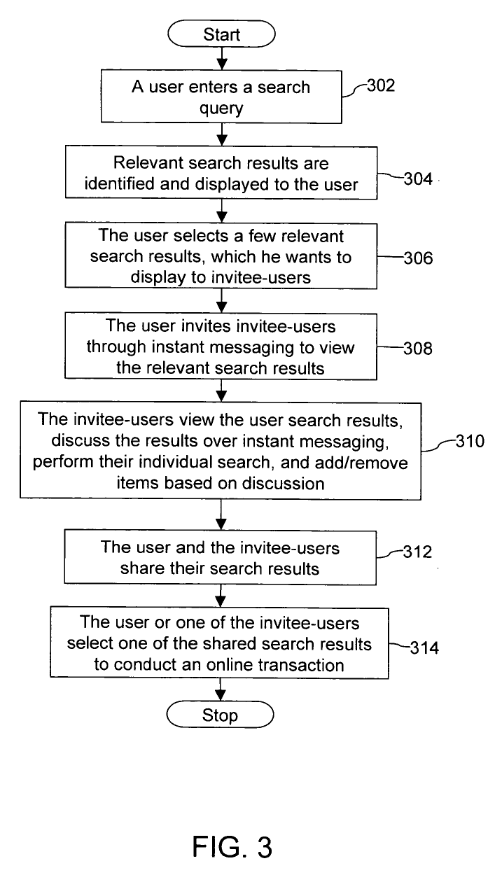

Thereafter at step 212, the user may invite several invitees to view, select, or discuss the relevant search results. Further details regarding the enablement of several invitees to view, select, or discuss the relevant search results have been discussed in conjunction with FIG. 3.

FIG. 3 is a flowchart representing a method of sharing the online shopping experience with other users, in accordance with one embodiment of the invention. At step 302, a user enters a search query for a particular shopping request, for example online purchase of tickets for an upcoming concert of Madonna. Subsequently, at step 304, relevant results for the search query are identified and displayed to the user. For example, the user may enter a search query like the one given below:
“Madonna concert ticket 50$”

Although the user specifies the name ‘Madonna’ in the search string, he/she might also be interested in buying tickets for ‘Madonna’ shows that are available at a different price or tickets, or even for some other artist's concerts.

In accordance with the disclosed method of online shopping, the user query will be interpreted as follows: first, the user is most interested in Madonna's concert tickets priced at $50 or less. Second, the user might also be interested in buying tickets at prices above $50, if they are not available at a lower price. Third, the user might also be interested in buying the tickets to a show by some other artist, like Bon Jovi or Britney Spears, for instance, in case he/she cannot find the tickets for the Madonna show at a price that interests him. The first category of results (Madonna's concert tickets at $50 or less) constitutes the most relevant search results. The second and third category of results constitutes the search results with limited relevance. The most relevant search results and the search results with limited relevance together constitute the relevant search results.

The disclosed method of online shopping displays these relevant search results to the user. For example, the displayed relevant results would pertain to ‘Madonna’ concert tickets priced at $50 or less. The results will also include ‘Madonna’ concert tickets priced above $50, and tickets for concerts by ‘Britney Spears’, ‘Bon Jovi’, and the like.

In this manner, the method for online shopping further enhances the shopping experience by providing context-based search results for shopping, instead of the conventional keyword-based search results.

At step 306, the user may select a few results that the user may find relevant. The search results to be displayed to other users are chosen by the user. The set of search results chosen by the user will hereinafter be referred to as user's choice results. For example, the user may select the results pertaining to ‘Madonna’ concert tickets priced at $50, $40 and $60 and the results pertaining to ‘Britney Spears’ concert tickets.

Thereafter, at step 310, the user invites one or more invitees to view the user's choice results. The invitation to view the search results is sent through an instant messaging service, such as AOL Instant Messenger (AIM™). If an invitee accepts the invitation from the user, the invitee can then view the user's choice results. Further, the user and the invitees can communicate with each other through instant messaging to discuss the search results. An invitee may also perform an individual search and choose a few search results from the set of search results displayed to the invitee and add to the set of user's choice results. The set of search results chosen by the invitee will hereinafter be referred to as invitee's choice results. For example, the invitee can enter a search query, such as (‘Metallica’ concert tickets $100). The search results, therefore, may pertain to ‘Metallica’ concert tickets, ‘Eagles’ concert tickets, ‘Deep Purple’ concert tickets, and the like. Further, the invitee can select the results related to ‘Metallica’ concert tickets and ‘Deep Purple’ concert tickets as invitee's choice results.

At step 312, the user's choice results and the invitees' choice results are displayed to the user and all the invitees. The user and all the invitee users can then discuss the shared search results with each other. The shared search results include user's choice results and invitees' choice results for all the invitees. Subsequently, at step 314, the user or one of the invitees selects one of the search results and performs the online shopping transactions. For example, one of the selected search results can be ‘Madonna’ concert tickets priced at $60.

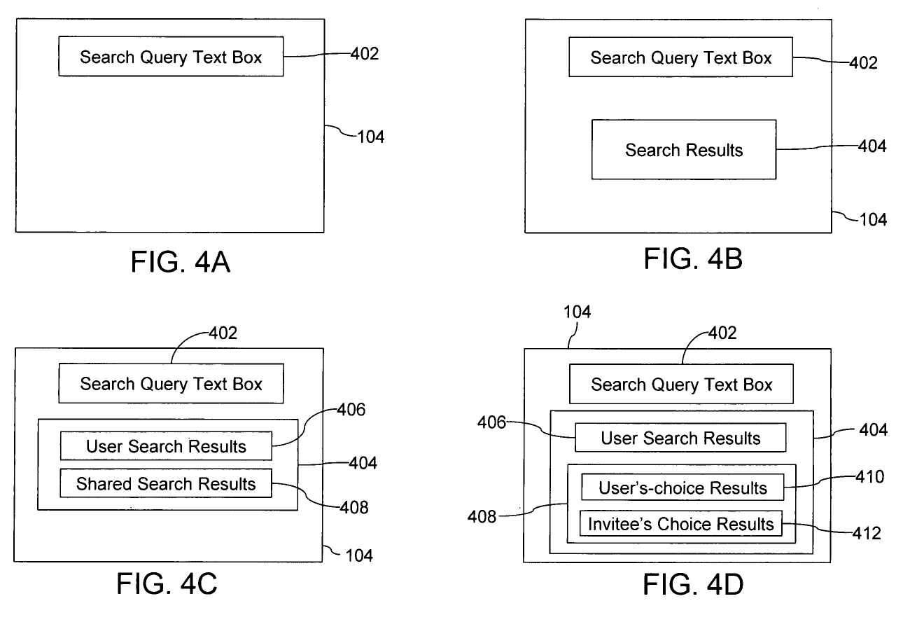

FIGS. 4A, 4B, 4C, and 4D are representations of the user interface during the execution of the method of sharing online experience, in accordance with one embodiment of the invention. FIGS. 4A, 4B, 4C, and 4D represent the graphical interface on user web browser 104.

FIG. 4A shows the interface visible on user-web browser 104 to user 102 before user 102 performs the search. User-web browser 104 consists of a search query text box 402. User 102 enters the search query in search query text box 402.

FIG. 4B shows the interface visible on user-web browser 104 when result display module 110 displays search results to user 102. The search results are displayed in a search results box 404. Thereafter, user 102 selects the user's choice search results.

FIG. 4C shows the interface visible on user-web browser 104 after user 102 has selected the user's choice results. Search results box 404 shows two tabs; a user search results tab 406 and a shared search results tab 408. User search results tab 406 displays the search results that were generated by query processor 108 in response to search query entered by user 102. Shared results tab 408 displays the user's choice results.

FIG. 4D shows the interface visible on user-web browser 104 after invitee 114 has selected the invitee's choice results. Shared results tab 408 displays a user's choice results tab 410 and an invitees' choice results tab 412. If more than one invitees 114 are present, invitees' choice results tab 412 shows invitees' choice results for all invitees. When invitees 114 add more results to their invitee's choice results, the results are added to invitees' choice results tab 412.

The invention provides a business method and a system for performing focused online shopping and sharing the online shopping experience with other users. The method of the invention enables a user to consult friends and informal subject-experts to solicit their opinions, or alternatively, to collaboratively make a decision prior to making important purchases. Further, the use of instant messaging as a communication medium, supported by a shared web browser, enables the user and the invitees to view and manipulate items of interest and discuss them simultaneously. Furthermore, the user or the invitees may revise and change the purchase-product characteristics and share these changes with others. The sharing of information allows feedback and exploration of alternatives. Further, the disclosed method shortens the buying cycle and enhances the online shopping experience.

The method of the invention may be implemented in various computer languages such as, Java, C, C++, Perl, Python, LISP, BASIC, Assembly, etc. The implementation of the method does not require any specific platform. Any platform that can provide means of support for simple arrays and associative arrays, which represent hierarchies, may be used.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include Random Access Memory (RAM) and Read Only Memory (ROM). Computer system further comprises storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A business method to provide a focused online shopping experience, the method comprising the steps of:
a. extracting the pertinent shopping-related information related to a pre-defined shopping context from a data set, the pre-defined shopping context having a set of attributes that define the shopping context;
b. storing the extracted pertinent shopping-related information in the form of a set of information-based directed acyclic graph (DAG) forests, the DAG forests being sets of DAGs, each DAG being a structural arrangement representing one attribute of the pre-defined shopping context;
c. converting a search query into a query-based DAG forest, the search query being entered by a user and pertaining to a shopping objective of the user;
d. identifying relevant results by comparing the query-based DAG forest with the information-based DAG forests;
e. displaying the relevant results to the user, in order to enable the user to make a shopping decision; and
f. enabling multiple users to discuss the relevant results, in order to enhance their shopping experience.

2. The business method of claim 1, wherein the step of extracting information comprises the steps of:
a. identifying relevant information from the data set, the relevant information being the information that relates to the set of attributes corresponding to the pre-defined shopping context; and
b. extracting data values from the relevant information, the data values being values of the attributes corresponding to the pre-defined shopping context.

3. The business method of claim 1, wherein the step of converting the search query into a query-based DAG forest comprises the steps of:
a. identifying the attributes pertaining to the search query;
b. constructing a DAG for each attribute of the search query; and
c. constructing a DAG forest corresponding to the constructed DAGs.

4. The business method of claim 1, wherein the step of comparing the query-based DAG forest with the information-based DAG forests comprises the steps of:
a. determining a graph-based similarity score between a DAG of the query-based DAG forest and a corresponding DAG of the information-based DAG forests; and
b. determining a forest-based similarity score as a function of all the graph-based similarity scores.

5. The business method of claim 4, wherein the relevant results are identified based on the forest-based similarity score.

6. The business method of claim 1, wherein the step of enabling multiple users to discuss the relevant results comprises the steps of:
a. entering the search query, the search query being entered by a user;
b. identifying relevant results for the entered search query;
c. inviting other users to view the relevant results over an instant messaging platform, the other users being invited by the user;
d. enabling the invited users to view the relevant results; and
e. discussing the relevant results over the instant messaging platform, the relevant results being discussed by multiple users.

7. The business method of claim 7 further comprising the step of selecting the best results based on the preferences of each user, the best results being selected by the multiple users.

8. The business method of claim 6 further comprising the steps of:
a. entering a new search query, the new search query being entered by one or more of the invited users; and
b. identifying new relevant results corresponding to the new search query.

9. The business method of claim 8, wherein the users are notified of the identification of the new relevant results.

10. A system for facilitating an enhanced online shopping experience, the system comprising:
a. a search page, to enter a search query, the search query being entered by a user;
b. a query processor, to identify the relevant results based on the search query;
c. a result-displaying module, to display the relevant results;
d. a control layer, to invite other users to view the relevant results; and
e. a shared session, the shared session being a user interface to show the relevant results to multiple users simultaneously.

11. The system of claim 10, wherein the control layer comprises an instant messaging platform, which allows the users to interact with each other.

12. The system of claim 10, wherein the result-displaying module allows the user to indicate preferences for the relevant results.

13. The system of claim 10, wherein the shared session is accessed and updated by multiple users simultaneously.

14. The system of claim 10, wherein the shared session comprises:
a. a search window, to allow other users to enter a new search query; and
b. a tab containing the collective results of each user participating in the shared session with the identity of each user and each result corresponding to the preference of that user.

15. A business method to provide a focused online shopping experience, the method comprising the steps of:
a. entering the search query, the search query being entered by a user;
b. identifying relevant results for the entered search query;
c. inviting invitees through an instant messaging platform to view the relevant results, the invitees being invited by the user;
d. enabling the invitees to view and modify the relevant results; and
e. discussing the relevant results over the instant messaging platform, the relevant results being discussed by the user and the invitees.
